(19) United States
(12) Patent Application Publication
(10) Pub. No.: US 2026/0275009 A1
(43) Pub. Date: Sep. 17, 2026

(54) METHOD TO PREPARE AMIDATED POLYMERS

(71) Applicant: Universiteit Gent, Gent (BE)

(72) Inventors: Richard HOOGENBOOM, Terneuzen (NL); Joachim VAN GUYSE, Gent (BE); Yann BERNHARD, Gent (BE)

(21) Appl. No.: 19/122,031

(22) PCT Filed: Oct. 20, 2023
(86) PCT No.: PCT/EP2023/079359

§ 371 Date: Apr. 17, 2025

(30) Foreign Application Priority Data
Oct. 20, 2022 (EP) 22202638.7

(51) Int. Cl. C08F 22/38

(52) U.S. Cl. CPC C08F 22/38

(57) ABSTRACT

The present invention relates to a method for the manufacturing of an amidated polymer from a polymer comprising at least one side-chain comprising an ester moiety, a hydrogel obtained from crosslinking said amidated polymer and uses thereof.

### CROSS-REFERENCE TO RELATED APPLICATIONS

This application is a national stage application under 35 U.S.C. § 371 of International Application No. PCT/EP2023/079359, filed Oct. 20, 2023, which International Application claims benefit of priority to European Application No. 22202638.7, filed Oct. 20, 2022, each of which is incorporated herein by reference in its entirety.

### FIELD OF THE INVENTION

The present invention relates to a method for the manufacturing of an amidated polymer from a polymer comprising at least one side-chain comprising an ester moiety, a hydrogel obtained from crosslinking said amidated polymer and uses thereof.

### BACKGROUND TO THE INVENTION

Post-polymerization modification, i.e. chemical manipulation of polymers to transform functionality, has been historically seen as a method to circumvent the restrictions imposed by the polymerization mechanism. However, this technique is increasingly perceived from another perspective, i.e. as a complementary tool to prepare functional polymers of equal viability than direct polymerization. This has been partly favored by the concomitant recent development of polyvalent and controllable polymerization techniques such as reversible-deactivation radical polymerization (RDRP), among others, giving access to controlled, “ready-to-be-modified” polymers, paired with the advent of highly directional click-type reactions, including, CuAAC, thiol-ene, thiol-yne and several others. This judicious combination is ideal to synthesize macromolecules with precise architectures, modular composition, functionality and topology.

Although post-polymerization modification seems to be a limitation-free method, the chemical method employed is preferably quantitative, chemoselective, and proceeds under mild conditions to avoid side-reactions and polymer backbone transformation. Hence, many post-polymerization approaches employ highly reactive groups such as N-hydroxysuccinimidyl (NHS) and pentafluorophenyl (PFP) activated ester, epoxides, anhydrides as well as click methods. Undoubtedly very useful, these methods can, however, hardly be directly implemented on many commodity polymers and request the preparation of “activated” polymeric precursors such as poly(N-hdroxysuccinimidyl acrylate) (PNHSA).

Therefore, the development of economic and versatile routes, i.e. activation/protection free methods, to directly convert industrial commodity polymers appears as a relevant alternative for the fabrication of large sets of functional materials for various applications.

The introduction on a polymeric structure via post-polymerization of amino groups is highly relevant, because amine functionality gives unique features such environmental responsivity, and are also ideal platforms for further functionalization, via acylation or alkylation by reaction with carboxyl, carbonyl, epoxy, Michael acceptors, to access more complex structures. Nevertheless, the introduction of amine functionalities in polymeric structure, particularly primary and secondary amines, is frequently hampered by their incompatibility with most of the polymerization mechanisms or contemporary post-polymerization modifications, therefore requesting the non-ideal use of protecting groups.

Richter et al., 2020, disclose polyacrylamides synthesized via RAFT polymerization, wherein polyacrylamides having side-chain amino groups have been prepared by radical polymerization of monomers having a protected (Boc) amino group.

Phuong et al., 2020 discloses the synthesis of ternary amphiphilic copolymers prepared via photoinduced electron transfer-RAFT (PET-RAFT) polymerization by statistical copolymerization of hydrophobic monomers with hydrophilic and cationic monomers. The hydrophilic and cationic monomers were fixed as HEAm and Boc-AEAm, respectively. Boc-AEAm was subsequently deprotected to reveal a primary amine.

A disadvantage of methods in the state of the art for the synthesis of polymers containing reactive amino groups in the side-chain, is that they require multiple steps, including protection-deprotection steps.

Wu et al., 2020 disclose the polymerization of protonated amino-functionalized monomers. This method is very restricted as it can only be performed in very polar solvents like water, making it impossible to make copolymers with water-insoluble comonomers.

Therefore, there is a need for alternative methods of preparation of polymers containing reactive amino groups in the side-chain, without the need of any protecting or activating groups, and ideally without the method of preparation leading to polymer-polymer chain-coupling problems.

### SUMMARY OF THE INVENTION

According to a first aspect, the present invention pertains to a method for the manufacturing of an amidated polymer i.e. a polymer resulted from an amidation reaction, wherein an ester moiety has been transformed to an amide moiety, the method comprising the steps of:
a) providing a polymer, such as a copolymer or homopolymer, having a polymer backbone and at least one side-chain, the side-chain comprising a group A represented by formula (I),

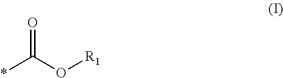

wherein
   [symbol] represents any atom or group which is part of the polymeric backbone, or of the side-chain attached to the polymer backbone; and
   R₁ is an alkyl group, either linear, branched, and optionally substituted;
b) providing a compound of formula (II),

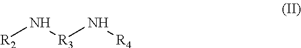

wherein
   R₂ is selected from H, and methyl;
   R₃ is a bivalent radical selected from alkylene, aminoalkylene, oxyalkylene, such as ethyl, propyl, butyl, ethoxyethyl, ethoxyethoxyethyl, ethyl(oligoethoxyethyl), ethylaminoethyl, ethylaminoethylaminoethyl, and ethyl(oligoaminoethyl);
   R₄ is a C₂-C₁₀ alkyl group, either linear, branched, and optionally substituted with one or more substituents selected from hydroxyl, azido, hydrazino, alkylamino, alkoxy, thiol, alkylthio, carboxylic acid, acylamino, and urea;
c) reacting the polymer provided at step a) with the compound provided at step b) in an amidation reaction;
d) obtaining an amidated polymer having one or more side-chains of formula (III),

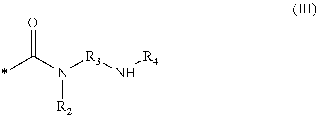

wherein [symbol] , R₂, R₃ and R₄ are defined as herein before.

An advantage according to the present aspect of the invention is that the method allows to obtain polymers comprising pendant reactive secondary amino groups (—R₃—NH—R₄) without the need for any protection/deprotection steps, and without coupling between the polymer chains taking place as it is surprisingly found that the secondary amine with a C₂-C₁₀ alkyl group, either linear, branched, and optionally substituted does not participate in the amidation reaction in presence of a primary amine or methyl-substituted secondary amine group. Further, the method according to the present invention can be easily conducted starting from available precursors, as it relies on post-polymerization steps. A further advantage of the present invention is that the obtained amidated polymers comprise amino groups which do not provide the need for activation and can readily be further functionalized.

According to a specific embodiment of the present invention, step b) comprises providing a compound of formula (II) wherein R₄ is ethyl. It has been found that the present embodiment provides for the best results while the resulting polymers are well-soluble in water. An advantage according to the present embodiment of the invention is that polymer chain coupling reactions during post-polymerization are further reduced, thereby obtaining easily derivatizable secondary amine moieties with minimal sterical hindrance for further modification while also retaining highest hydrophilicity.

According to an embodiment of the present invention, step a) comprises providing a polymer wherein in formula (I) the R₁ group is selected from the list comprising: methyl, ethyl, butyl, preferably methyl. An advantage according to the present embodiment of the invention is that milder reaction conditions are required for the amidation reaction to take place, without the need for activated substrates. Further, an advantage of the present embodiment is that the reaction of step c) can be performed in the absence of a solvent.

According to an embodiment of the present invention, step a) comprises providing a polymer wherein the at least one side-chain comprises a spacer X, connecting the group A represented by formula (I) to said polymer backbone, and selected from the list comprising: ethyl, propyl, butyl.

According to a further embodiment of the present invention, step b) comprises providing a compound selected from the list: N-ethylethylenediamine, N-propylethylenediamine, N-ethyl-propylenediamine, N-propylpropylenediamine, N-ethyl-N′-methylethylenediamine, An advantage according to the present embodiment of the invention is that the low molar mass compounds allow introducing the secondary amine while retaining high water solubility of the resulting polymers.

According to a further embodiment of the present invention, step a) comprises providing a polymer selected from the list: poly(methyl acrylate) (PMA), poly(methyl methacrylate) (PMMA), poly(methyl 4-vinylbenzoate), poly(2-methoxycarbonylethyl-2-oxazoline), poly(2-methoxycarbonylpropyl-2-oxazoline), and copolymers thereof. An advantage according to the present embodiment of the invention is that these polymers are readily available and can be efficiently modified with the here described methodology.

According to yet a further embodiment of the present invention step a) comprises providing poly(methyl acrylate) (PMA), poly(methyl methacrylate) (PMMA), poly(methyl 4-vinylbenzoate), poly(2-methoxycarbonylethyl-2-oxazoline) or poly(2-methoxycarbonylpropyl-2-oxazoline), and step b) comprises providing N-ethylethylenediamine, N-propylethylenediamine, N-ethyl-propylenediamine, N-propylpropylenediamine or N-ethyl-N′-methylethylenediamine.

According to yet a further embodiment of the present invention step b) comprises further providing a compound of formula (IV),

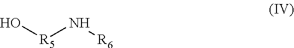

wherein
   R₅ is a bivalent radical selected from the list comprising: alkylene, aminoalkylene, oxyalkylene, substituted or unsubstituted, cyclic or linear;
   R₆ is selected from H, and methyl.

An advantage according to the present embodiment of the invention is that this allows control over the amount of secondary amino groups and charge density along the hydrophilic copolymers, while the presence of the aminoalcohol accelerates the coamidation process. Copolymers obtained from acrylamides and activated esters are known to be prone to hydrolysis. The present embodiment advantageously overcome the drawbacks of methods of synthesis of copolymers from acrylamides in the state of the art.

According to a further embodiment of the present invention, the compound of formula (IV) is selected from the list comprising: ethanolamine, propanolamine, butanolamine, pentanolamine, 1-amino-2-propanol, aminoglycerol, aminosaccharides. An advantage according to the present embodiment of the invention is that hydrophilic biocompatible copolymers can be obtained.

According to yet a further embodiment of the present invention, step b) comprises further providing a compound of formula (IX),

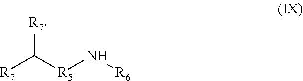

wherein
   R₅ is a bivalent radical selected from the list comprising: alkylene, aminoalkylene, oxyalkylene, substituted or unsubstituted, cyclic or linear;
   R₆ is selected from H, and methyl; and
   R₇ and R₇′ are independently selected from a C₁-C₄ alkyl group, preferably R₇ and R₇′ are both methyl, or ethyl, more preferably R₇ and R₇′ are both methyl.

An advantage according to the present embodiment of the invention is that this allows control over the amount of secondary and tertiary amino groups, as well as the pKa of the ionizable groups of the hydrophilic polymer. Control of the pKa of the ionizable groups provides control of the buffering capacity of the hydrophilic polymer.

According to yet a further embodiment of the present invention, the method is comprising:
e) reacting the secondary amine group —R₃—NH—R₄ of the amidated polymer obtained at step d) with a compound adapted to provide the resulting amidated polymer with at least one crosslinkable group.

An advantage according to the present embodiment of the invention is that this provides efficient access to polymer precursors for the preparation of polymer hydrogels and polymer networks.

According to yet a further embodiment of the present invention the compound adapted to provide the resulting amidated polymer with at least one crosslinkable group is selected from the list: acrylamide, methacrylamide, allyl, propargyl.

In a further aspect, the present invention provides for an amidated polymer having one or more side-chains of formula (V),

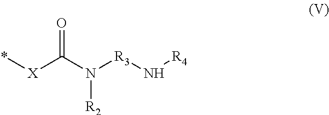

wherein
   R₂, R₃, R₄ are groups defined in embodiments of the present invention;
   X is a spacer optionally present, defined in embodiments of the present invention;
   [symbol] represents any atom or group which is part of the polymeric backbone, or of the side-chain attached to the polymer backbone.

An advantage according to the present aspect of the invention is that these polymers can be used as reactive precursors and as cationic polymer and are not readily accessible through radical polymerization due to unwanted side-reactions of monomers containing secondary amino-groups and the poor solubility in organic solvents of these monomers when protonated.

According to an embodiment of the present invention, the amidated polymer is comprising a monomeric unit of formula (VI):

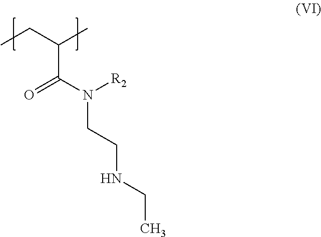

wherein R₂ is a group defined in one or more embodiments of the present invention.

An advantage according to the present embodiment of the invention is that this is a hydrophilic polymer that can be used as reactive precursor for further modification or as cationic polymer in water.

According to an embodiment of the present invention the amidated polymer is further comprising one or more side-chains of formula (VII),

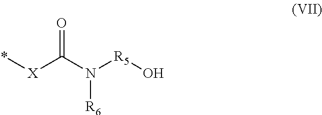

wherein
   R₅, R₆ are groups defined in one or more embodiments of the present invention;
   X is a spacer optionally present, defined in one or more embodiments of the present invention;
   [symbol] represents any atom or group which is part of the polymeric backbone, or of the side-chain attached to the polymer backbone.

An advantage according to the present embodiment of the invention is that these polymers have a controlled cationic charge density that results from the amount of secondary amino-groups and that the polymers are very hydrophilic.

According to a further embodiment of the present invention, the amidated polymer is of formula (VIII),

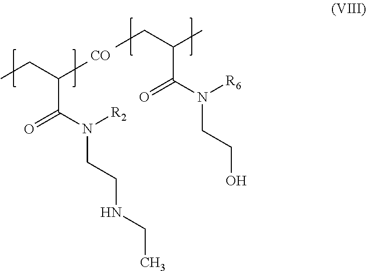

wherein R₂, R₆ are groups defined in one or more embodiments of the present invention.

An advantage according to the present embodiment of the invention is that this is a hydrophilic copolymer in which the hydroxyethylacrylamide provides good biocompatibility and the secondary amino groups can be used as reactive groups or as cationic groups.

According to an embodiment of the present invention, the amidated polymer is further comprising one or more side-chains of formula (X),

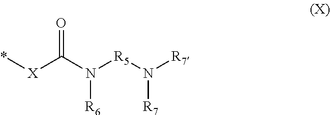

wherein
   R₅, R₆ R₇, and R_{y} are groups defined in one or more embodiments of the present invention;
   X is a spacer optionally present, defined in one or more embodiments of the present invention;
   [symbol] represents any atom or group which is part of the polymeric backbone, or of the side-chain attached to the polymer backbone.

According to a further embodiment of the present invention, the amidated polymer is further comprising at least 2 side-chains having at least one crosslinkable group connected to the secondary amine group as defined in formula (V). An advantage according to the present embodiment of the invention is that these polymers can be used as precurors for polymer hydrogels and polymer networks.

According to a further embodiment of the present invention, the amidated polymer is of formula (XI),

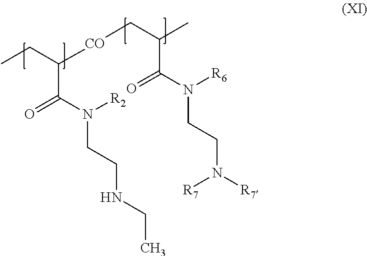

wherein R₂, R₇, and R_{7′} are groups defined in one or more embodiments of the present invention.

In a further aspect, the present invention provides for a hydrogel obtained from crosslinking the amidated polymer defined according to any embodiment of the present invention.

In yet a further aspect, the present invention provides for the use of an amidated polymer defined according to any embodiment of the present invention for nucleic acid delivery. An advantage according to the present aspect of the invention is that the charge density and the hydrophobic/hydrophilic balance can be easily controlled for nucleic acid delivery.

In yet a further aspect, the present invention provides for the use of an amidated polymer defined according to any embodiment of the present invention for layer-by-layer assembly

An advantage according to the present aspect of the invention is that the protonated secondary amino side-chains have a cationic charge-enabling their use for electrostatic LBL assembly as well as for the formation of polyion complexes.

In yet a further aspect, the present invention provides for the use of an amidated polymer defined according to any embodiment of the present invention for adsorption to surfaces.

An advantage according to the present aspect of the invention is that the high structural variability of the polymer enables enhanced adsorption driven by a combination of electrostatic interactions and hydrophobic interactions.

### BRIEF DESCRIPTION OF THE DRAWINGS

With specific reference now to the figures, it is stressed that the particulars shown are by way of example and for purposes of illustrative discussion of the different embodiments of the present invention only. They are presented in the cause of providing what is believed to be the most useful and readily description of the principles and conceptual aspects of the invention. In this regard no attempt is made to show structural details of the invention in more detail than is necessary for a fundamental understanding of the invention. The description taken with the drawings making apparent to those skilled in the art how the several forms of the invention may be embodied in practice.

FIG. 1, also abbreviated as FIG. 1, illustrates overlay of normalized SEC-RI traces of the starting PMA and the PHEAM-co-PEAEAM copolymers obtained after amidation with NEED/EA molar ratio ranging from 0:6 to 6:0.

FIG. 2, also abbreviated as FIG. 2, illustrates overlay of normalized SEC-RI traces of the starting PMA and the PHEAM-co-PEAEAM copolymers obtained after amidation with NEED/NDED molar ratio ranging from 4:0 to 0:4.

### DETAILED DESCRIPTION OF THE INVENTION

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous. When describing the compounds of the invention, the terms used are to be construed in accordance with the following definitions, unless a context dictates otherwise.

The term “about” or “approximately” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” or “approximately” refers is itself also specifically, and preferably, disclosed.

As used in the specification and the appended claims, the singular forms “a”, “an”, and “the” include plural referents unless the context clearly dictates otherwise. By way of example, “a polymer” means one polymer or more than one polymer.

The compounds of the present invention can be prepared according to the reaction schemes provided in the examples hereinafter, but those skilled in the art will appreciate that these are only illustrative for the invention and that the compounds of this invention can be prepared by any of several standard synthetic processes commonly used by those skilled in the art of organic chemistry.

When describing the compounds of the invention, the terms used are to be construed in accordance with the following definitions, unless a context dictates otherwise:

The term “alkyl” by itself or as part of another substituent refers to a fully saturated hydrocarbon of formula CₓH₂ₓ₊₁ wherein x is a number greater than or equal to 1. Generally, alkyl groups of this invention comprise from 1 to 20 carbon atoms. Alkyl groups may be linear or branched and may be substituted as indicated herein. When a subscript is used herein following a carbon atom, the subscript refers to the number of carbon atoms that the named group may contain. Thus, for example, C₁₋₄alkyl means an alkyl of one to four carbon atoms. Examples of alkyl groups are methyl, ethyl, n-propyl, i-propyl, butyl, and its isomers (e.g. n-butyl, i-butyl and t-butyl); pentyl and its isomers, hexyl and its isomers, heptyl and its isomers, octyl and its isomers, nonyl and its isomers; decyl and its isomers. C₁-C₆ alkyl includes all linear, branched, or cyclic alkyl groups with between 1 and 6 carbon atoms, and thus includes methyl, ethyl, n-propyl, i-propyl, butyl and its isomers (e.g. n-butyl, i-butyl and t-butyl); pentyl and its isomers, hexyl and its isomers, cyclopentyl, 2-, 3-, or 4-methylcyclopentyl, cyclopentylmethylene, and cyclohexyl.

The term “substituted alkyl” refers to an alkyl group substituted with one or more substituents (for example 1 to 4 substituents, for example 1, 2, 3, or 4 substituents or 1 to 2 substituents) at any available point of attachment. Non-limiting examples of such substituents include halo, hydroxyl, carbonyl, nitro, amino, oxime, imino, azido, hydrazino, cyano, aryl, heteroaryl, cycloalkyl, acyl, alkylamino, alkoxy, thiol, alkylthio, carboxylic acid, acylamino, alkyl esters, carbamate, thioamido, urea, sullfonamido and the like. For example, substituted alkyl groups can be substituted alkyl groups comprising one or more amino and and/or oxy groups, either on the carbon chain (e.g. —CH₂—CH₂—NH—CH₂—CH₃, —CH₂—CH₂—O—CH₂—CH₃) or as an H substituent (e.g. —CH₂—CH(—NH₂)—CH₂—CH₃, —CH₂—CH(—OH)—CH₂—CH₃).

According to the present invention, by means of the term “bivalent radical”, reference is made to a group with two single bonds for attachment to two other groups, such as and not limited to, an alkylene group, a aminoalkylene group, a oxyalkylene group. Non-limiting examples of alkylene groups includes methylene, ethylene, methylmethylene, trimethylene, propylene, tetramethylene, ethylethylene, 1,2-dimethylethylene, pentamethylene and hexamethylene. Similarly, where alkenyl groups as defined above and alkynyl groups as defined above, respectively, are bivalent radicals having single bonds for attachment to two other groups, they are termed “alkenylene” and “alkynylene” respectively. In the context of the present invention, by means of the term aminoalkylene reference is made to an alkylene group comprising an amino group in the carbon chain (e.g. —CH₂—CH₂—NH—CH₂—CH₂—). By means of the term oxyalkylene, reference is made to an alkylene group comprising an oxy group, either on the carbon chain (e.g. —CH₂—CH₂—O—CH₂—CH₂—) or as an H substituent (e.g. —CH₂—CH(—OH)—CH₂—CH₂—).

According to a first aspect, the present invention pertains to a method for the manufacturing of an amidated polymer.

In the context of the present invention, by means of the term “amidated polymer”, reference is made to a polymer comprising one or more side-chains having a group of formula:

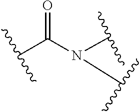 [SMILES: *C(=O)N(*)*]

The method according to the present invention comprises a first step a) of:
a) providing a polymer, such as a copolymer or homopolymer, having a polymer backbone and at least one side-chain comprising a group A represented by formula (I),

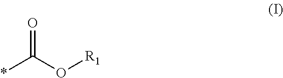

wherein
   [symbol] represents any atom or group which is part of the polymeric backbone, or of the side-chain attached to the polymer backbone; and
   R₁ is an alkyl group, either linear, branched, and optionally substituted.

Different polymers can be provided at step a). For example, polymers which can be provided at step a) are polymers which can have been subjected to a post-polymerization reaction providing for the group of formula A, or which do not require any type of further synthetic steps other than the polymerization reaction. A variety of polymers, comprising a group A as defined in accordance with the present invention can be provided, such as, and not limited to, any one of a polyacrylate, polymethacrylate, polystyrene, poly(vinyl ether), poly(2-oxazoline), polyamide, polypeptide, polypeptoid, polyethers, poly(alkyl glyoxylate), and copolymers thereof.

Polymers suitable to be provided at step a) therefore comprise at least one ester moiety-(C═O)—O—R₁, wherein R₁ is an alkyl group, either linear, branched, and optionally substituted.

Different R₁ alkyl groups are suitable to carry out the present invention. R₁ groups according to the present inventions are groups which are adapted to provide the formation of an amide functionality via an amidation reaction, wherein an —O—R₁ is replaced by an amino or substituted amino group. As specified previously, according to the present invention, R₁ is an alkyl group, either linear, branched, and optionally substituted. According to an embodiment of the present invention, step a) comprises providing a polymer wherein in formula (I) the R₁ group comprises an aminoalkylene such as an oligoamine or oxyalkylene moiety, such as a polyoxyethylene. oligoethyleneglycol or methoxyethyl

According to an embodiment of the present invention, step a) comprises providing a polymer wherein in formula (I) the R₁ group is selected from the list comprising: methyl, ethyl, butyl, preferably methyl.

In group A as defined at step a) [symbol] represents any atom or group which is part of a polymer side-chain or a polymer backbone. For example, in case the polymer provided at step a) is a poly(methyl acrylate), [symbol] represents an atom part of the poly(methyl acrylate) backbone, wherein in case the polymer provided at step a) is poly(methyl 4-vinylbenzoate), [symbol] represents an atom part of an aromatic ring, part of the polymer side-chain. In accordance with the present invention, [symbol] can be a spacer linking a group A of formula (I) with a polymer backbone or part of a polymer side chain. In the context of the present invention, by means of the term “spacer”, or “linker”, reference is made to a flexible molecular segment used to link two molecular groups together e.g. a side-chain to a polymer backbone.

In the context of the present invention, by means of the term “side-chain”, reference is made to a pendant chain, in other words a chemical group that is attached to a core part of a molecule, e.g. a polymer backbone. In particular, reference is made to an oligomeric or polymeric offshoot from a polymer backbone.

In the context of the present invention, by means of the term “polymer backbone”, reference is made to the main chain of a polymer, in other words, the polymer backbone is the linear chain to which all other chains, long or short or both, may be regarded as being pendant.

According to an embodiment of the present invention, step a) comprises providing a polymer wherein the at least one side-chain comprises a spacer X selected from the list comprising: ethyl, propyl, butyl.

According to an embodiment of the present invention, the polymer provided at step a) is a polymer selected from the list: poly(methyl acrylate) (PMA), poly(methyl methacrylate) (PMMA), poly(methyl 4-vinylbenzoate), poly(2-methoxycarbonylethyl-2-oxazoline), poly(2-methoxycarbonylpropyl-2-oxazoline), and copolymers thereof.

Further, the method according to the present invention comprises the step of:
b) providing a compound of formula (II),

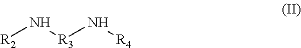

wherein
   R₂ is selected from H, and methyl;
   R₃ is a bivalent radical selected from the list comprising: alkylene, aminoalkylene, oxyalkylene, substituted or unsubstituted, cyclic or linear, such as ethyl, propyl, butyl, ethoxyethyl, ethoxyethoxyethyl, ethylaminoethyl, ethylaminoethylaminoethyl;
   R₄ is a C₂-C₁₀ alkyl group, either linear, branched, and optionally substituted with one or more substituents selected from hydroxyl, azido, hydrazino, alkylamino, alkoxy, thiol, alkylthio, carboxylic acid, acylamino, and urea.

After step b), the present invention comprises the step c) of:
c) reacting the polymer provided at step a) with the compound provided at step b);
Step b) according to the present invention therefore comprises providing a compound of formula (II). The compound of formula (II) comprises at least one NH₂— or CH₃NH— moiety and at least one —NHR₄ moiety. In accordance with the present invention, the at least one NH₂— or CH₃NH— moiety is provided to react with the side-chain comprising a group A represented by formula (I), thereby providing the formation of an amide moiety from an ester moiety (amidation reaction), whereas the at least one —NHR₄ moiety is provided to not take part in said amidation reaction. In other words, the at least one —NHR₄ moiety is not provided to form an amide with the group A represented by formula (I) at the reaction conditions of step c). By not taking part in the reaction of step c), the further cross-linking of the polymer provided at step a) can be prevented. Hence, the compound of formula (II) provided at step b) comprises at least one secondary amine group group —R₃—NH—R₄.

At step b), the compound of formula (II) provided at step b) comprises R₄ is a C₂-C₁₀ alkyl group, either linear, branched, and optionally substituted with one or more substituents selected from hydroxyl, azido, hydrazino, alkylamino, alkoxy, thiol, alkylthio, carboxylic acid, acylamino, and urea. In other words, R₄ is a group comprising from 2 to 10 carbon atoms. Examples of unsubstituted R₄ groups in accordance with the present invention are ethyl, propyl(n-propyl, isopropyl, c-propyl), butyl (n-butyl, sec-butyl, isobutyl, tert-butyl), pentyl (n-pentyl, tert-pentyl, neopentyl, isopentyl, sec-pentyl, 3-pentyl, sec-isopentyl, 2-methylbutyl), hexyl, heptyl, octyl, nonyl, decyl.

It was unexpectedly found that when R₄ ethyl or larger that the secondary amine does not undergo amidation with the side chain ester groups and that the amidation proceeds selectively on the primary amino group or N-methyl substituted secondary amine group. Hence the secondary amino group can be introduced in the side chain without inducing polymer chain coupling. When R₄ is methyl both the primary and the N-methyl secondary amino groups participate in amidation leading to significant polymer chain coupling. When both chain ends are N-ethyl substituted secondary amine groups significant chain coupling occurs too. Similarly, when a compound with one primary amine at the chain end a second sterically hindered primary amine attached to the middle of the chain, there is also significant polymer chain coupling, indicating that it is a quite unexpected invention that sterically hindered secondary amino groups, with at least an ethyl substituent do not lead to polymer chain coupling and allow efficient incorporation of the secondary amino groups in the polymer side chain.

In a specific embodiment of the present invention R₄ is ethyl.

Therefore, the step c) according to the method for the manufacturing of an amidated polymer according to the present invention is an amidation reaction, which can be carried out with or without the presence of a catalyst. Catalytic systems are clearly the most advantageous, and among them, organo-catalytic ones possess several advantages such as low price and water insensibility.

Catalysts particularly suitable to carry out step c) are amidation catalysts selected from the list comprising Triazabicyclo-decene (TBD), Guanidine, Trimethylamine, Diazabicyclo-undecene (DBU), Methyl-triazabicyclo-decene (MTBD), Triazabicyclo-octene, Sn(Oct)₂ and Ti(alkoxide)₄.

In a preferred embodiment, step c) is a triazabycyclodecene (TBD) catalyzed amidation. Further, the use of H-bonding unit bearing substrates in TBD-catalyzed amidation of polyesters such as poly(methyl) acrylate (PMA) have a favorable impact on the reaction kinetics, leading to an “autocatalytic accelerated” amidation process. Therefore, in yet a further, preferred, embodiment of the present invention, step c) further comprises carrying out the amidation in the presence of an H-bonding unit bearing substrate, such as an aminoalcohol.

After step c), the present invention comprises the step d) of:
d) obtaining an amidated polymer having one or more side-chains of formula (III),

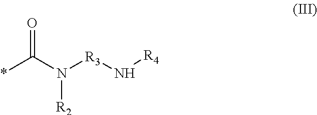

An advantage according to the present aspect of the invention is that the method of the present invention allows to obtain polymers comprising pendant reactive secondary amino groups without the need for any protection/deprotection steps, and without coupling between the polymer chains taking place. Further, the method according to the present invention can be easily conducted starting from available precursors, as it relies on post-polymerization steps. A further advantage of the present invention is that the obtained amidated polymers comprise amino groups which do not provide the need for activation, and can readily be further functionalized or protonated to obtain cationic polymers.

Further, the method according to the present invention is advantageous in that it requests a low catalyst loading and comparatively short reaction times. Yet a further advantage of the present invention is that high incorporation degree of the amine group is attainable. Yet a further advantage of the present invention is that it provides a way to reliably obtain the desired functionalization degree simply by modulating the ratio between amine reactants.

According to a further embodiment of the present invention, step b) comprises providing a compound selected from the list: N-ethylethylenediamine (NEED), N-propylethylenediamine, N-ethyl-propylenediamine, N-propylpropylenediamine, N-ethyl-N′-methylethylenediamine.

According to yet a further embodiment of the present invention step a) comprises providing poly(methyl acrylate) (PMA), poly(methyl methacrylate) (PMMA), poly(methyl 4-vinylbenzoate), poly(2-methoxycarbonylethyl-2-oxazoline) or poly(2-methoxycarbonylpropyl-2-oxazoline), and step b) comprises providing N-ethylethylenediamine (NEED), N-propylethylenediamine, N-ethyl-propylenediamine, N-propylpropylenediamine or N-ethyl-N′-methylethylenediamine.

According to yet a further embodiment of the present invention step b) comprises further providing a compound of formula (IV),

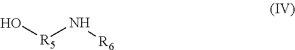

wherein
   R₅ is a bivalent radical selected from the list comprising: alkylene, aminoalkylene, oxyalkylene, substituted or unsubstituted, cyclic or linear;
   R₆ is a group selected from H, and methyl.

An advantage of the present embodiment is that functionalized co-polymers comprising-OH moieties can be obtained, which are valuable water soluble, non-ionic anti-fouling polymers found in various biomedical applications.

According to an embodiment of the present invention, the compound of formula (II) and the compound of formula (IV) are provided in a ratio of compound of formula (II) to compound of formula (IV) from 10/1 to 1/10, preferably 10/1 to 1/1, most preferably, 10/1 to 3/1.

According to a further embodiment of the present invention the compound of formula (IV) is selected from the list comprising: ethanolamine, propanolamine, butanolamine, pentanolamine, 1-amino-2-propanol, aminoglycerol, aminosaccharides.

According to yet a further embodiment of the present invention, step b) comprises further providing a compound of formula (IX),

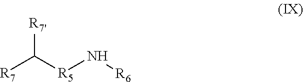

wherein
   R₅ is a bivalent radical selected from the list comprising: alkylene, aminoalkylene, oxyalkylene, substituted or unsubstituted, cyclic or linear;
   R₆ is selected from H, and methyl; and
   R₇ and R₇′ are independently selected from a C₁-C₄ alkyl group, preferably R₇ and R₇′ are both methyl, or ethyl, more preferably R₇ and R₇′ are both methyl.

An advantage of the present embodiment is that functionalized co-polymers comprising both secondary amino and tertiary amino moieties can be obtained, which are valuable water soluble, polymers found in various biomedical applications.

According to yet a further embodiment of the present invention the method is comprising:
e) reacting the secondary amine group —R₃—NH—R₄ of the amidated polymer obtained at step d) with a compound adapted to provide the resulting amidated polymer with at least one crosslinkable group.

In the context of the present invention, by means of the term “crosslinkable group”, reference is made to a chemical group which is adapted to be crosslinked. In other words, reference is made to a chemical group which is provided to undergo crosslinking reaction, wherein a bond or a short sequence of bonds is formed, linking together one polymer chain to another. According to yet a further embodiment of the present invention the compound adapted to provide the resulting amidated polymer with at least one crosslinkable group is selected from the list: acrylamide, methacrylamide, allyl, propargyl, carboxylic acid, activated ester, maleimide, thiol, selenol.

Step e) according to the present invention therefore comprises reacting the —NH— of the —R₃—NH—R₄ group with a compound adapted to provide the resulting amidated polymer with at least one crosslinkable group. According to the present embodiment, crosslinkable groups can be provided to the polymer according to a variety of methods and reagents in the state of the art. Suitable crosslinkable groups can be, and are not limited to, methacrylamide, allyl, propargyl, carboxylic acid, maleimide, thiol, and selenol. These crosslinkable groups can be provided by reacting the amidated polymer with methacryloyl chloride for obtaining methacrylamide, ally bromide for allyl, propargylbromide for propargyl, succinic anhydride for carboxylic acid, 6-Maleimidohexanoic acid N-hydroxysuccinimide ester for maleimide, thiolactone for thiol, selenolactone for selenol.

The choice of the compound adapted to provide the resulting amidated polymer with at least one crosslinkable group depends on several factors, such as the type of amidated polymer or co-polymer.

Further, the amidated polymers according to the present invention can also be crosslinked directly. For example, the —R₃—NH—R₄ group can be reacted with epichlorohydrin/bis-epoxide, biscarbonate, bis isocyanate, or aldehydes.

In a further aspect, the present invention provides an amidated polymer having one or more side-chains of formula (V),

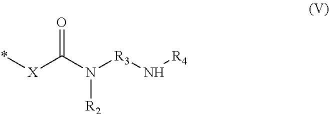

wherein
   R₂, R₃ and R₄ are groups defined in one or more embodiments of the present invention
   X is a spacer optionally present, defined in one or more embodiments of the present invention;
   [symbol] represents any atom or group which is part of the polymeric backbone, or of the side-chain attached to the polymer backbone.

According to an embodiment of the present invention, the amidated polymer is comprising a monomeric unit of formula (VI),

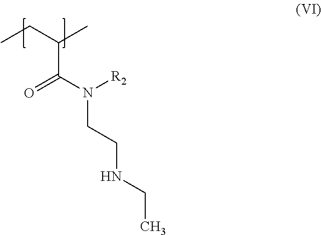

wherein R₂ is a group defined in one or more embodiments of the present invention.

In the context of the present invention, by means of the term “monomeric unit”, reference is made to the largest constitutional unit contributed by a single monomer molecule to the structure of a macromolecule or oligomer molecule. In the context of the present invention, it is evident that at least one or more atoms of [symbol] are part of a polymer backbone.

For the present embodiment, it is apparent that formula (VI) is encompassed by formula (V) wherein the spacer X is absent and [symbol] is

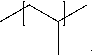

According to yet a further embodiment of the present invention, the amidated polymer is poly(N-(2-(ethylamino)ethyl) acrylamide), also referred to as PEAEAM.

According to a further embodiment of the present invention, the amidated polymer is further comprising one or more side-chains of formula (VII),

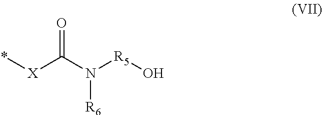

wherein
   R₅, R₆ are groups defined in one or more embodiments of the present invention;
   X is a spacer optionally present, defined in one or more embodiments of the present invention;
   [symbol] represents any atom or group which is part of the polymeric backbone, or of the side-chain attached to the polymer backbone.

According to a further embodiment of the present invention, the amidated polymer is of formula (VIII),

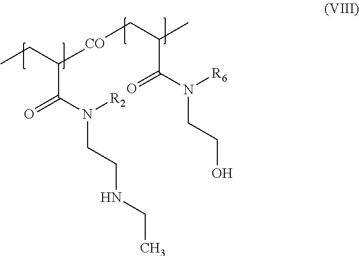

wherein R₂, R₆ are groups defined in one or more embodiments of the present invention.

According to yet a further embodiment of the present invention, the amidated polymer is poly(N-(2-(ethylamino)ethyl-co-N-hydroxyethyl acrylamide), also referred to as P (EAEAM-co-PHEAM).

According to a further embodiment of the present invention, the amidated polymer is further comprising one or more side-chains of formula (X),

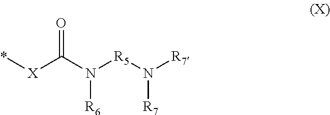

wherein
   R₅, R₆ R₇, and R_{7′} are groups defined in one or more embodiments of the present invention;
   X is a spacer optionally present, defined in one or more embodiments of the present invention;
   [symbol] represents any atom or group which is part of the polymeric backbone, or of the side-chain attached to the polymer backbone.

According to a further embodiment of the present invention, the amidated polymer is of formula (XI),

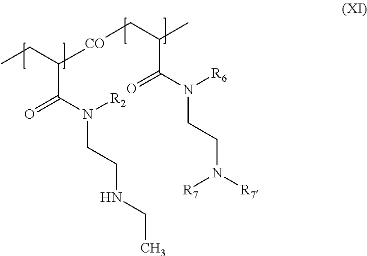

wherein R₂, R₇, and R_{7′} are groups defined in one or more embodiments of the present invention.

According to a further embodiment of the present invention, the amidated polymer is further comprising at least 2 side-chains having at least one crosslinkable group connected to the secondary amine group as defined in formula (V).

In a further aspect, the present invention provides for a hydrogel obtained from crosslinking the amidated polymer defined according to any embodiment of the present invention. Hydrogels according to the present invention can be used for the development of new materials for various biomedical applications including nucleic acid delivery, drug and gene delivery, responsive systems, antimicrobial agents, and others.

In the context of the present invention, by means of the term “hydrogel”, reference is made to a gel wherein the swelling agent is an aqueous fluid. In other words, reference is made to a polymer network which has been expanded by means of a swelling agent. In the context of the present invention, by means of the term “swelling agent”, as used herein, unless indicated otherwise, reference is made to an agent which is capable of increasing the volume of a swellable composition according to the present invention by absorption of said agent. For example, swelling agents according to the present invention are, but not limited to, water, serum, lipo-aspirate, intravenous fluids, NaCl solution, glucose solution, Hartmann solution, stem cell solution, blood plasma, buffers, such as DMEM, HEPES, and combinations thereof.

In yet a further aspect, the present invention provides for the use of an amidated polymer defined according to any embodiment of the present invention as a polylysine analogue for nucleic acid delivery (such DNA, RNA, miRNA and siRNA) or in anti-fouling coatings, as a cationic polymer for layer-by-layer assembly or flocculation, and as a reagent in polyurethanes and in epoxy resins. Another use of the amidated polymer is for adsorption to surfaces.

### EXPERIMENTAL PART

### Materials and Methods

### Materials

The following chemicals were purchased from various providers (Sigma Aldrich, TCI Europe, Fluka) and used as received, unless otherwise stated: Acetonitrile (MeCN, ≥99%), acetone (≥99%), methanol (MeOH, ≥99%) chloroform (≥99%), diethylether (Et₂O, ≥99%), tetrahydrofuran (THF, ≥99%), triazabicyclodecene (TBD, 98%), ethylenediamine (ED, ≥99%), N-ethyl ethylenediamine (NEED, >99.0%), N-methyl ethylenediamine (NMED, >97.0%), 1,3-diaminopentane (DAP), N,N′-diethyl ethylenediamine (DEED), N-ethyl-N′-methyl ethylenediamine (EMED), N,N-diethylethylenediamine (NDED), acryloyl chloride (>97.0%), trimethylamine (>99%) DL-Dithiothreitol (DTT) (≥98%). Irgacure (trademark) 2959 was kindly donated by BASF. PMA was purchased from Scientific Polymer Products (40.08% solution in toluene, Approx. Mw: 40,000 g·mol⁻¹). The toluene from PMA was removed by evaporation under vacuum using a rotary evaporator until no toluene signal was visible by 1H-NMR analysis. Dialysis membranes (regenerated cellulose—MWCO 3.5 kDa) were acquired from Roth. Acidic resin (Dowex (trademark), 50W X8, hydrogen form, strongly acidic, 16-50 mesh) was purchased from Sigma Aldrich and washed with methanol and then water before use.

### Methods

Nuclear magnetic resonance (1H-NMR) spectra were measured at room temperature with a Bruker Advance MSL 400 MHz or 300 MHz NMR spectrometer. All chemical shifts are given in parts per million (o, ppm) relative to tetramethylsilane. Deuterated solvents, such as chloroform-d, and dimethylsulfoxide-d₆, were purchased from Eurisotop. Size exclusion chromatography (SEC) was performed on an Agilent 1260-series HPLC system equipped with a 1260 online degasser, a 1260 ISO-pump, a 1260 automatic liquid sampler (ALS), a thermostatted column compartment (TCC) set at 50° C. equipped with two PLgel 5 μm mixed-D columns (7.5 mm×300 mm) and a precolumn in series, a 1260 diode array detector (DAD) and a 1260 refractive index detector (RID). Distilled N,N-dimethyl acetamide (DMA) containing 50 mM of LiCl was used at eluant at a flow rate of 0.5 mL min⁻¹. Number-averaged molar mass values (Mₙ, and M_{w}) and molar mass distribution (dispersity, Ð) values were calculated against narrow dispersity polymethylmethacrylate (PMMA) standards from PSS. FT-IR spectra were measured on a PerkinElmer 1600 series FTIR spectrometer and are reported in wavenumber (cm⁻¹). Centrifugation was performed on an ALC multispeed refrigerated centrifuge PK 121R from Thermo Scientific using 15 mL or 50 mL high clarity polypropylene conical tubes from Falcon. Lyophilization was performed on a Martin Christ freeze-dryer, model Alpha 2-4 LSC plus. Ultrapure deionized water (Milli Q) was prepared with a resistivity less than 18.2 MΩ×cm using an Arium 611 from Sartorius with the Sartopore (trademark) 2 150 (0.45+0.2 μm pore size) cartridge filter. Photocrosslinking kinetics were studied by performing small strain oscillatory shear experiments on an Anton Paar MCR302 Rheometer with 25 mm parallel plate-plate geometry at R.T. Samples were irradiated using an Omnicure Series 2000 ultraviolet light source with 365 nm filter and a fiber optic probe fitted under the quartz bottom plate of the rheometer.

### Experiments

### General Procedure for (Co-) Amidation Reaction

Amidation reactions were conducted in sealed microwaves tubes. PMA (1 g, 40 kDa, 0.05 mmol corresponding to approx. 23.25 mmol of methyl ester group) was weighed in 20 mL flasks (20 mL microwaves tubes). Amines (EA, ED, NMED, NEED, DAP, DEED or EMED) of predetermined ratio (139.5 mmol, 6 eq. per methyl ester group) were introduced in the flasks and the solutions were degassed by argon bubbling for 15 min. TBD (0.05-0.25 eq. per methyl ester) was then added to the mixtures and the flasks were flushed with Argon, capped and heated at 80° C. over a period of 72 h (protected from light). To evaluate the reaction conversion, a sample (100 μL) was precipitate in cold diethyl ether (5 mL), centrifuged, dried under vacuum at 40° C. for 2 h, and analyzed by FTIR.

General Work-Up Procedure after Amidation with ED, NMED, NEED, EA, DEED, EMED and Copolymers Thereof

After return to room temperature, the mixture was poured into 100 ml of cold acetone to precipitate the polymer. The solution was centrifuged, and the liquid supernatant discarded. The polymer was further precipitated twice by dissolving in a minimal amount of methanol (3-5 mL) and pouring in cold counter-solvent (50 mL). The polymer was dried under vacuum (R.T., 2 h) to remove residual solvent. To remove TBD and residual traces of amines, the resultant polymer was dissolved in water (around 50 mL), and for each sample, Dowex (650 mg, around twice the mass of TBD) was added. After stirring for 5 hours and filtration to remove the Dowex, water was removed by freeze drying and the resultant solid was dried in a vacuum oven at 40° C. overnight to yield the desired pure polymer as a white powder.

### General Procedure for the Derivatization by Acetylation for the SEC Analysis

A homo- or copolymer sample (100 mg) was poured in 1 mL acetic anhydride (around 15 eq. per functional group, i.e. OH groups+NH groups) in presence of a catalytic amount of N,N-dimethylaminopyrridine (DMAP) (11 mg, 0.1 eq. per functional group). The reaction was stirred at 40° C. overnight. After return to room temperature, the mixture was poured into 10 ml of cold diethyl ether to precipitate the polymer. The solution was centrifuged, and the liquid supernatant discarded. The polymer was further precipitated twice by dissolving in a minimal amount MeOH (1 mL) and pouring in cold counter-solvent (10 mL). The polymer was dried under vacuum (R.T., 2 h) and then analyzed.

General Procedure for the Acylation of PEAEAM-Co-PHEAM Copolymers with Methacryloyl Chloride

0.5 g of the polymer was poured in 5 mL of dry DMF under inert atmosphere. A little amount of hydroquinone was added to the mixture. Then dry triethylamine (4 eq. per amine group) followed by methacryloyl chloride (2 eq. per amine group) were added, and the mixture was stirred at room temperature in the dark overnight. The following purification steps were also conducted as much as possible in the dark. The mixture was poured into 20 ml of cold diethyl ether to precipitate the polymer. The solution was centrifuged, and the liquid supernatant discarded. The polymer was further precipitated twice by dissolving in a minimal amount MeOH (2-3 mL) and pouring in cold counter-solvent (20 mL). The polymer was then poured into a 1M KOH/MeOH mixture (50:50, 5 mL) and the mixture was stirred at room temperature for 5 h to cleave the O-acetylated by product. The methanol was evaporated, and the resultant aqueous solution was neutralized to pH 7 with 1 M HCl. The mixture was put in a 3.5 kDa Mw cutoff dialysis bag and dialysed 3 times against deionized water. Water was removed by freeze drying and the resultant solid was dried in a vacuum oven at 40° C. for 2 h to yield the desired pure polymer as a white powder.

### Curing Experiment

In situ photo-crosslinking experiments were conducted with 10 wt % solutions of (PEAEAM-co-PHEAM) copolymers with 14% functionalization degree of methacryloyl groups in water as solvent, in presence of photo-initiator (Irgacure2959) (0.05 eq. per methacryloyl groups) and eventually (2S,3S)-1,4-Bis-sulfanylbutane-2,3-diol (DTT) (0.5 eq. per methacryloyl group). The solution (around 0.2 mL) was deposit on the Rheometer glass plate and the gap was fixed at 0.4 mm (25 mm diameter upper profile). The storage and loss modulus were measured over a total period over 665 sec with a gamma amplitude for the (oscillating) shear deformation at 0.1% and a deformation frequency of 1 Hz. The baseline was measured during 1 min, then the solution was irradiated with the UV lamp at room temperature.

### Polymer Characterizations

The polymers were generally characterized by FTIR, 1H-NMR in various solvent and SEC analysis with DMA/1 mass % LiCl as the eluent to confirm the polymer structures.

### Results and Discussion

### Post-Polymerization Modification of PMA

Aiming for the modification of bulk, commodity polymer, we used commercially available PMA (around 40 kDa average molar mass (Mₙ)) as a starting material.

The TBD-catalyzed amidation was explored with bifunctional amines, i.e. ethylenediamine (ED), alkylated amines including N-methyl ethylenediamine (NMED), N-ethyl ethylenediamine and (NEED), (see Scheme 1). In addition, TBD-catalyzed amidation was investigated with 1,3-diaminopentane (DAP), N,N′-diethyl ethylenediamine (DEED) and N-ethyl-N′-methyl ethylenediamine (EMED).

Further, co-amidation with EA was also explored, giving access to amine functionalized water soluble compounds, non-ionic anti-fouling polymers found in various biomedical applications. Such a copolymer therefore impose itself as an adequate platform for a large range of applications.

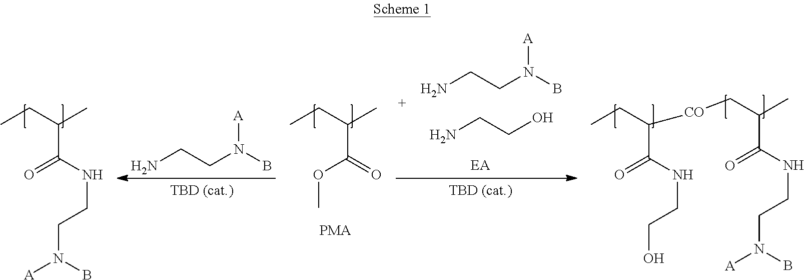

Scheme 1 illustrates the general scheme of post-polymerization modification of PMA with amines to gives poly(N-alkyl acrylamide) s homo- and copolymers, and structure of the diverse amine explored, wherein the amine reactants are: A=B═H (ED), A=Me B═H (NMED), A=Et B═H (NEED), A=B=Et (DEED), A=Et B=Me (EMED).

### Comparative Example—Post-Polymerization Modification of PMA with ED

We firstly explored the reaction with ED, as the more direct and simple route to introduce a N-aminoethyl side-chain group. For standard conditions, the equivalents of TBD were set at 0.05 (5 mol %) and the amines at 6, both related to methyl ester groups, and the reaction was performed at 80° C., because these conditions are optimal to reach a full conversion of the methyl ester groups when the amine reactant is ethanolamine (EA). In the case of ED, only co-amidation with EA was explored, in order to reduce the anticipated potential crosslinking through the reaction from both amines of ED. The reactions conversions were evaluated by FTIR, by comparison of the methyl ester peak (C═O_{(vibration)} at 1726 cm⁻¹) and the amide peak (C═O_{vibration} at 1642 cm⁻¹) from a reaction sample which was precipitate in diethyl ether, centrifuged and dried. Although we could easily reach full conversion after 24 hours of reaction, it was clear that the reactions systematically lead to undesired crosslinking (see Scheme 2). The propensity to crosslink was judged qualitatively (SEC was not measured because of insoluble samples), by visual observation of an eventual insoluble fraction in the reaction bulk or during work-up. A premature cross-linkage was observed regardless of the reaction conditions, even with the use of an excess of EA as a co-reactant, either in neat conditions or diluted in MeCN. Scheme 2 illustrates the postmodification of PMA with ethylenediamine leading to crosslinking.

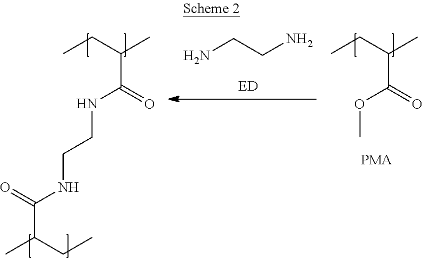

Post-Polymerization Modification of PMA with N-Alkylated Diamines (NMED, NEED)

Next, we investigated the modification of PMA with mono-N-alkylated diamines, i.e. NMED, in order to discriminate between the reactivity of a primary amine and a secondary amine, thus eliminating the need of a protecting group (see Scheme 3, which illustrates the post-polymerization modification of PMA with secondary amines leading either to crosslinking (NMED) or efficient introduction of the secondary amino-groups in the side-chains without crosslinking (NEED)). The modification of PMA with N-methyl ethylenediamine (NMED) presents a comparative example, while the modification of PMA with N-ethyl ethylenediamine (NEED) presents an example according to the invention.

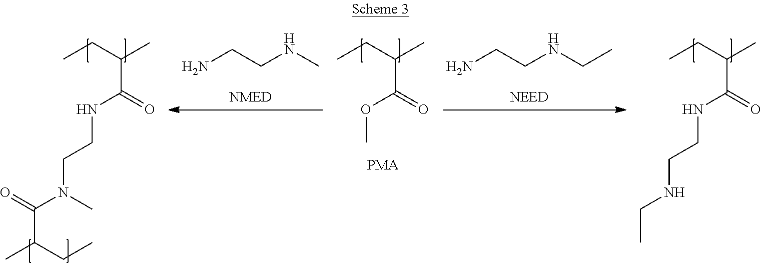

### Comparative Example—Post-Polymerization Modification of PMA with DAP

Next, we investigated the modification of PMA with 1,3-diaminopentane (DAP), a diamine containing a terminal primary amino group and a sterically hindered primary amino group. Amidation of PMA with DAP led to the formation of a crosslinked polymer indicating that both amino groups participated in the amidation reaction.

Post-Polymerization Modification of PMA with N,N′-Dialkylated Diamines

Next, we investigated the modification of PMA with N,N′-diethyl ethylenediamine (DEED), a diamine containing two equal N-ethylamine groups. Amidation of PMA with DEED led to the formation of a crosslinked polymer indicating that both amino groups participated in the amidation reaction. In contrast, amidation of PMA with N-ethyl-N′-methyl diethylenediamine led to efficient introduction of the N-ethyl secondary amine groups through a selective amidation reaction with the N-methyl secondary amine groups. The modification of PMA with N,N′-diethyl ethylenediamine (DEED) presents a comparative example, while the modification of PMA with N-ethyl-N′-methyl ethylenediamine (EMED) presents an example according to the invention.

### Example—Post-Polymerization Modification of PMA with NEED and EA

Then, we extended the method to prepare a range of copolymers of PEAEAM and PHEAM of various composition, as well as the PEAEAM homopolymer, by simple modulation of the NEED and EA ratio during the amidation reaction (Scheme 4). For every amine ratio, a reaction time of 18 h, in neat conditions, at 80° C. and using only 5% of TBD per methyl esters were sufficient conditions to attain the full conversion of the methyl ester, which was confirmed by FTIR analysis, except for the reaction with 100% NEED as a reactant which required a longer reaction time (40 h).

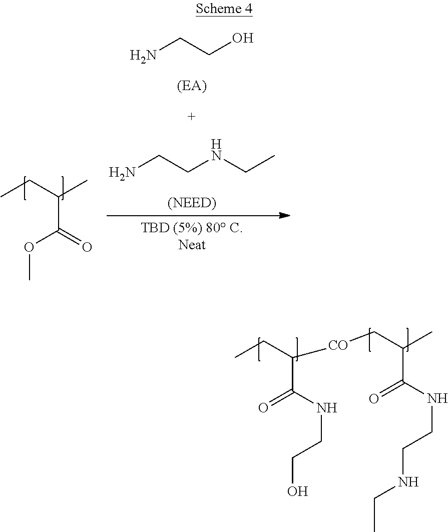

The properties of the polymers obtained from amidation of PMA with NEED/EA as determined by ¹H-NMR and SEC analysis are listed in Table 1.

TABLE 1

| | | | | | | | | Derivatized (O/N- | | |
|---|---|---|---|---|---|---|---|---|---|---|
| | | Conv. Me | | Ratio | Non derivatized | | | acetylated) | | |
| | Eq. | ester | | EAEAM/HEAM | Mₙ | M_{w} | | Mₙ | M_{w} | |
| Entry | NEED/EA | 18 h | 40 h | units^{a} | (kDa)^{b} | (kDa)^{b} | Ð^{b} | (kDa)^{b} | (kDa)^{b} | Ð^{b} |
| 1 | Starting PMA | | | | 50.4 | 96.4 | 1.91 | 50.4 | 96.4 | 1.91 |
| 2 | 0:6 | Full | Full | 0:100 | 114.2 | 192.4 | 1.68 | 135.0 | 308.2 | 2.28 |
| 3 | 1:5 | Full | Full | 4:96 | 85.1 | 164.1 | 1.93 | 96.1 | 261.6 | 2.72 |
| 4 | 2:4 | Full | Full | 9:91 | 79.6 | 157.3 | 1.98 | 92.3 | 283.7 | 3.07 |
| 5 | 3:3 | Full | Full | 20:80 | 78.4 | 155.4 | 1.98 | 89.7 | 248.6 | 2.77 |
| 6 | 4:2 | Full | Full | 35:65 | — | — | — | 91.6 | 219.2 | 2.39 |
| 7 | 5:1 | Full | Full | 60:30 | — | — | — | 121.2 | 244.9 | 2.00 |
| 8 | 6:0 | Not | Full | 100:0 | — | — | — | 146.2 | 235.8 | 1.61 |
| | | full | | | | | | | | |

^{a}By ¹H-NMR in D₂O, from the purified polymers
^{b}By SEC versus PMMA standards (DMA 1% LiCl), measured for the purified polymers, before or after derivatization

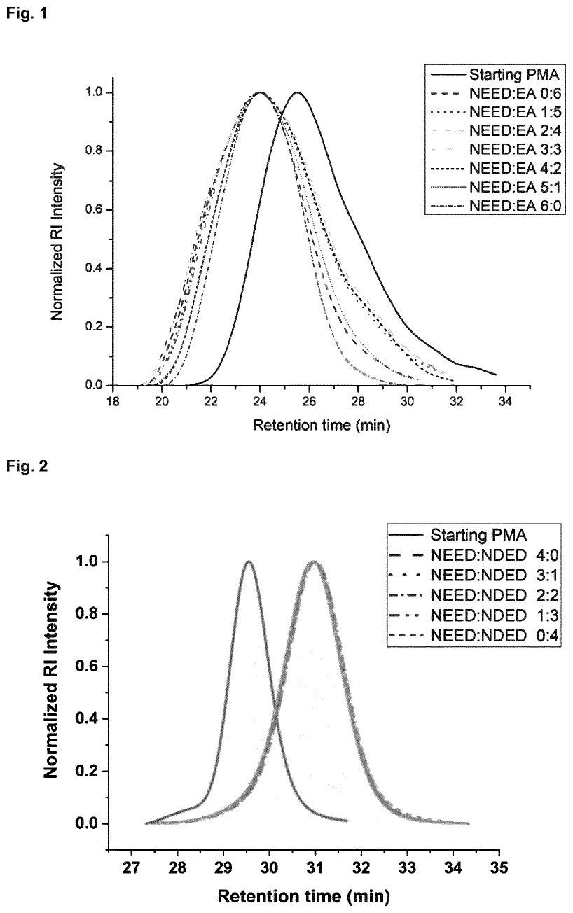

All obtained (co) polymers revealed similar elution peak profiles in SEC as the starting PMA, with a clear shift in retention time (see FIG. 1), indicating the absence of significant chain coupling side reactions. For an equimolar amounts of EA and NEED (stoichiometric ratio 0.5), a polymer with 20% EAEAM functionality is obtained in line with previous observations that EA has a higher amidation reactivity. To remove the TBD catalyst, dialysis after acidic treatment could be used. Alternatively, the employment of an acidic resin (Dowex) in water turned out be more straightforward and offers the possibility to recover and reuse the catalyst. Overall, the use of NEED is very beneficial, and allow to access the novel PEAEAM homopolymers and (PHEAM-CO-PEAEAM) copolymers in a controllable, economic and straightforward manner, without polymer coupling.

The applicability of this reactive platform to access hydrogel material was then explored. The reactive nature of the secondary amine groups was subsequently exploited to install methacryloyl groups, which would enable facile photo-initiated network formation via either free radical or thiol-ene chemistry. For this purpose a PHEAM-co-PEAEAM copolymer (with 20% EAEAM units) was reacted with methacryloyl anhydride in presence of triethylamine, followed by basic hydrolysis of the O-acetylated by-product (see Scheme 5, which illustrates the postmodification of P (EAEAM-co-HEAM) with methacryloyl anhydride and consecutive crosslinkage).

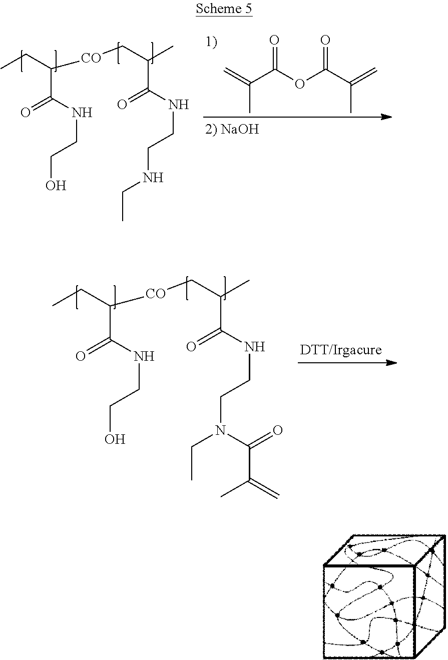

After dialysis, a polymer with 14% functionalization degree was obtained, as determined by integration of the protons signal of the methacryloyl groups versus the signal of the protons from the backbone on the 1H-NMR. The polymer was subsequently subjected for photo-initiated curing with and without dithiol crosslinker, in presence of Irgacure as a photoinitiator. The tests were implemented by strain oscillatory shear rheological experiments with in-situ irradiation promoted photocrosslinkage. For both experiments, a clear crossover point highlight the sol-gel transition, although it is reached faster for the experiment with DDT. The storage modulus attained is also higher for this latter experiment, reaching up to 10 kPa.

### Example—Post-Polymerization Modification of PMA with NEED and NDED

The method was further extended to prepare a range of copolymers of PEAEAM and PHNDEDM of various composition, by modulation of the NEED and NDED ratio during the amidation reaction (Scheme 6). For every amine ratio, a reaction time of 72 h, in neat conditions, at 80° C. and using only 5% of TBD per methyl esters were sufficient conditions to attain the full conversion of the methyl ester, which was confirmed by FTIR analysis or ¹H NMR analysis.

[symbol]

The properties of the polymers obtained from amidation of PMA with NEED/NDED as determined by ¹H-NMR and SEC analysis are listed in Table 2.

TABLE 2

| | | | Ratio | | |
|---|---|---|---|---|---|
| | Eq. | Conv. | EAEAM/ | Non derivatized | |
| | NEED/ | Me ester | DEAM | Mₙ | |
| Entry | NDED | 72 h | units^{a} | (kDa)^{b} | Ð^{b} |
| 1 | Starting PMA | | | 10.1^{c} | 1.07^{c} |
| 2 | 4:0 | Full | 1:0 | 23.6 | 1.11 |
| 3 | 3:1 | Full | 0.75:0.25 | 24.2 | 1.11 |
| 4 | 2:2 | Full | 0.5:0.5 | 23.7 | 1.11 |
| | 1:3 | Full | 0.25:0.75 | 24.6 | 1.10 |
| 5 | 0:4 | Full | 0:1 | 23.9 | 1.12 |

^{a}By ¹H-NMR in D₂O, from the purified polymers
^{b}By SEC versus PEG standards (methanol-sodium acetate buffer containing 0.1M NaNO₃), measured for the purified polymers
^{c}By SEC versus PMMA standards

All obtained (co) polymers revealed similar elution peak profiles in SEC as the starting PMA, with a clear shift in retention time (see FIG. 2), indicating the absence of significant chain coupling side reactions. Normalized SEC traces of PMA were measured with N,N-dimethylacetamide as eluent, while the modified PMA with different ratios of NEED and NDED were measured with water as eluent.

### REFERENCES

1. Richter, Friederike, et al. “Tuning of endosomal escape and gene expression by functional groups, molecular weight and transfection medium: a structure-activity relationship study.” Journal of Materials Chemistry B 8.23 (2020): 5026-5041.
2. Phuong, Pham Thu, et al. “Effect of hydrophobic groups on antimicrobial and hemolytic activity: Developing a predictive tool for ternary antimicrobial polymers.” Biomacromolecules 21.12 (2020): 5241-5255.
3. Wu, Meng, et al. “Ultra elastic, stretchable, self-healing conductive hydrogels with tunable optical properties for highly sensitive soft electronic sensors.” Journal of Materials Chemistry A 8 (2020) 24718-24733.

1-15. (canceled)

16. A method for manufacturing an amidated polymer, the method comprising:
a) providing a polymer having a polymer backbone and at least one side-chain comprising a group A represented by formula (I) 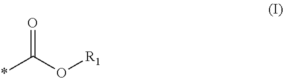
wherein [symbol]
represents any atom or group that is part of the polymer backbone, or part of the side-chain attached to the polymer backbone; and
R₁ is a substituted or unsubstituted, linear or branched alkyl group;
b) providing a compound of formula (II) 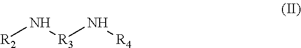
wherein
R₂ is selected from H and methyl;
R₃ is a bivalent radical selected from substituted or unsubstituted, cyclic or linear alkylene, aminoalkylene, and oxyalkylene;
R₄ is a substituted or unsubstituted, linear or branched C₂-C₁₀ alkyl group;
c) reacting the polymer provided at step a) with the compound provided at step b); and
d) obtaining an amidated polymer having one or more side-chains of formula (III)

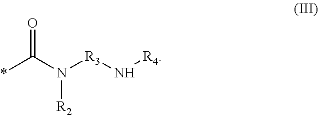

17. The method according to claim 16, wherein step b) comprises providing the compound of formula (II) wherein R₄ is ethyl.

18. The method according to claim 16, wherein in the polymer provided in step a), R₁ is selected from methyl, ethyl, and butyl.

19. The method according to claim 16, wherein in the polymer provided in step a), the at least one side-chain comprises a spacer X, connecting the group A represented by formula (I) to the polymer backbone, wherein the spacer X is selected from ethyl, propyl, and butyl.

20. The method according to claim 16, wherein the compound provided in step b) is selected from N-ethylethylenediamine, N-propylethylenediamine, N-ethyl-propylenediamine, N-propylpropylenediamine, and N-ethyl-N′-methylethylenediamine.

21. The method according to claim 16, wherein the polymer provided in step a) is selected from poly(methyl acrylate), poly(methyl methacrylate), poly(methyl 4-vinylbenzoate), poly(2-methoxycarbonylethyl-2-oxazoline), poly(2-methoxycarbonylpropyl-2-oxazoline), and copolymers thereof.

22. The method according to claim 16, wherein step b) comprises further providing a compound of formula (IV): 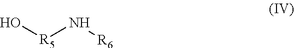
wherein
R₅ is a substituted or unsubstituted, cyclic or linear bivalent radical selected from alkylene, aminoalkylene, and oxyalkylene; and
R₆ is selected from H and methyl.

23. The method according to claim 16, further comprising:
reacting the —NH— of the —R₃—NH—R₄ group of the amidated polymer obtained at step d) with a compound adapted to provide a resulting amidated polymer with at least one crosslinkable group.

24. The method according to claim 16, wherein R₄ is substituted with one or more substituents selected from hydroxyl, azido, hydrazino, alkylamino, alkoxy, thiol, alkylthio, carboxylic acid, acylamino, and urea.

25. An amidated polymer having one or more side-chains of formula (V), 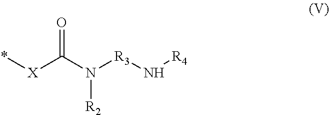
wherein
R₂ is selected from H and methyl;
R₃ is a substituted or unsubstituted, cyclic or linear bivalent radical selected from alkylene, aminoalkylene, and oxyalkylene;
R₄ is a substituted or unsubstituted, linear or branched C₂-C₁₀ alkyl group;
X is a spacer optionally present, selected from ethyl, propyl, and butyl; and [symbol]
represents any atom or group which is part of the polymer backbone, or of the side-chain attached to the polymer backbone.

26. The amidated polymer according to claim 25, comprising a monomeric unit of formula (VI), 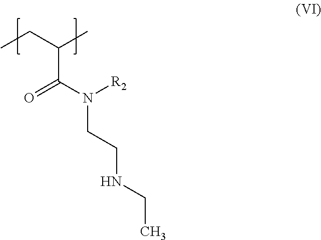
wherein R₂ is selected from H and methyl.

27. The amidated polymer according to claim 25, further comprising one or more side-chains of formula (VII), 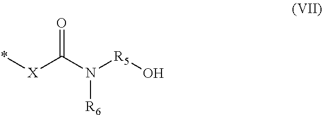
wherein
R₅ is a substituted or unsubstituted, cyclic or linear bivalent radical selected from alkylene, aminoalkylene, and oxyalkylene;
R₆ is selected from H and methyl;
X is a spacer optionally present, selected from ethyl, propyl, and butyl; and [symbol]
represents any atom or group which is part of the polymer backbone, or part of the side-chain attached to the polymer backbone.

28. The amidated polymer according to claim 27, wherein the amidated polymer is represented by formula (VIII), 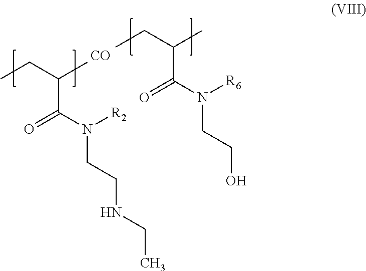
wherein R₂ and R₆ are independently selected from H and methyl.

29. The amidated polymer according to claim 25, further comprising at least 2 side-chains having at least one crosslinkable group connected to the —R₃—NH—R₄ group of formula (V).

30. The amidated polymer according to claim 25, wherein R₄ is ethyl.

31. A hydrogel comprising the amidated polymer according to claim 29, in a crosslinked state.
